(19) United States
(12) Patent Application Publication
(10) Pub. No.: US 2025/0001581 A1
(43) Pub. Date: Jan. 2, 2025

(54) FLYING DISC RETRIEVAL TOOL

(71) Applicants: DAVID EUGENE CHAPIN, HOUSTON, TX (US); DAVID WINSTON CHAPIN, ROCKWALL, TX (US)

(72) Inventors: DAVID EUGENE CHAPIN, HOUSTON, TX (US); DAVID WINSTON CHAPIN, ROCKWALL, TX (US)

(21) Appl. No.: 18/216,406

(22) Filed: Jun. 29, 2023

(51) Int. Cl. B25J 1/02; A63H 33/18

(52) U.S. Cl. CPC B25J 1/02; A63H 33/18

(57) ABSTRACT

A flying disc retrieval tool includes an extendable handle and a bow including an elongate bar connected to the extendable handle, and first and second struts downwardly extending from first and second ends of the elongate bar. The tool further includes a bow string secured between the first and second struts, wherein the first and second struts position the bow string a vertical distance from the elongate bar. The tool also includes one or more posts, where each post is coupled to both the elongate bar and the bow string. Each post is coupled to the elongate bar at positions providing substantially uniform lateral distances between the first strut and one of the posts closest to the first strut, between the second strut and one of the posts closest to the second strut, and between any adjacent pair of the posts to form a plurality of side-by-side disc capture bays.

### BACKGROUND

The present disclosure relates to apparatus used to retrieve a flying disc that is not easily reachable, such as a flying disc that has sunk to the bottom of a pond during a game of disc golf.

### BACKGROUND OF THE RELATED ART

A flying disc (hereinafter referred to simply as a “disc”) is a lightweight gliding toy or sporting item. Each “disc” has a generally circular shape about a central axis and a cross-sectional profile forming an airfoil that allows the disc to fly by reducing drag and increasing lift as the disc moves through the air. Spinning the disc imparts a stabilizing gyroscopic force, allowing the disc to be aimed with accuracy and thrown for distance.

A flying disc may be used recreationally and competitively for throwing and catching, including a variety of flying disc games or competitions. Such games include ultimate (also referred to as ultimate frisbee) and disc golf. Disc golf is a sport played on a course that includes a sequence of targets, such as a wire basket with hanging chains above the basket designed to catch a disc in mid-flight. However, a disc golf course may be created in a public park or greenspace that may also contain various types of terrain, including water features such as ponds, lakes, creeks, rivers, and/or fountains. Unfortunately, an errant throw may lead to a disc landing in one of the water features and becoming practically unreachable by the player alone.

### BRIEF SUMMARY

One embodiment provides a flying disc retrieval tool comprising an extendable handle and a bow including an elongate bar connected to the extendable handle, a first strut downwardly extending from a first end of the elongate bar and a second strut downwardly extending from a second end of the elongate bar. The tool further comprises a bow string having a first end secured to the first strut, a second end secured to the second strut, and a central portion that extends from the first strut to the second strut, wherein the first and second struts position the bow string a vertical distance from the elongate bar. Still further, the tool comprises one or more posts, each post having a first end coupled to the elongate bar and a second end coupled to the bow string, wherein the one or more posts are coupled to the elongate bar at positions providing substantially uniform lateral distances between the first strut and one of the posts closest to the first strut, between the second strut and one of the posts closest to the second strut, and between any adjacent pair of the posts to form a plurality of side-by-side disc capture bays.

Some embodiments provide a method of using the flying disc retrieval tool to retrieve a flying disc. The method comprises extending the extendable handle, resting the bow on a surface that is supporting the disc in a position beyond the disc, pulling the handle to draw the bow along the surface until the disc is captured in one of the plurality of side-by-side disc capture bays, and retrieving the disc from the bow. The method may use any embodiment of the flying disc retrieval tool described herein.

### BRIEF DESCRIPTION OF THE SEVERAL VIEWS OF THE DRAWINGS

FIG. 1 is an illustration of a person using a flying disc retrieval tool to retrieve a flying disc from a pond.

FIG. 2 is a perspective view of the flying disc retrieval tool according to one embodiment.

FIGS. 3A-B are end views showing two embodiments of the flying disc retrieval tool having a first bow forming two disc capture bays and a second bow forming three disc capture bays, respectively.

FIGS. 4A-B are partial end views of a bow having left and right ends securing the ends of a bow string and a first embodiment of a floating pin that is connected to both the bow and the bow string.

FIGS. SA-B are partial end views of a bow having first and second ends securing first and second ends of a bow string and a second embodiment of a floating pin that is connected to both the bow and the bow string.

FIG. 6 is a partial side view of the flying disc retrieval tool showing a first end of the bow string secured to a first end of the bow.

FIGS. 7A-B are schematic top views of the flying disc retrieval tool illustrating how a disc is drawn into one of the bays.

FIGS. 8A-B are schematic side views of the flying disc retrieval tool illustrating how a disc is drawn into one of the bays.

FIG. 9 is an end view of a disc that has been captured in one of the bays of the flying disc retrieval tool.

FIGS. 10A-B are partial side views of the flying disc retrieval tool illustrating a connection between the handle and the bow.

FIG. 10C is a top view of the bow and disconnected handle positioned side-by-side and strapped together for storage.

FIGS. 11A-B are top and bottom perspective views of a handle bracket that supports the handle at a fixed angle to the bow.

FIG. 11C is a top perspective view of the handle bracket in a released condition allowing the handle to pivot relative to the bow.

FIG. 12 is a perspective view of the handle connected to the bow according to an alternative embodiment.

FIGS. 13A-B are end views of the bow illustrating potential lateral deflection of a post.

### DETAILED DESCRIPTION

One embodiment provides a flying disc retrieval tool comprising an extendable handle and a bow including an elongate bar connected to the extendable handle, a first strut downwardly extending from a first end of the elongate bar and a second strut downwardly extending from a second end of the elongate bar. The tool further comprises a bow string having a first end secured to the first strut, a second end secured to the second strut, and a central portion that extends from the first strut to the second strut, wherein the first and second struts position the bow string a vertical distance from the elongate bar. Still further, the tool comprises one or more posts, each post having a first end coupled to the elongate bar and a second end coupled to the bow string, wherein the one or more posts are coupled to the elongate bar at positions providing substantially uniform lateral distances between the first strut and one of the posts closest to the first strut, between the second strut and one of the posts closest to the second strut, and between any adjacent pair of the posts to form a plurality of side-by-side disc capture bays.

The lateral distances between adjacent pairs of posts and/or struts are slightly less than a diameter of a targeted or standard flying disc. The lateral distance between adjacent pairs of posts and/or struts establishes the lateral dimension of each disc capture bay. The disc capture bays may be described as being rectangular, but minor variations or deviations such as rounded corners are permitted. The lateral distance and the lateral dimension of each disc capture bay is slightly smaller than the diameter of the targeted or standard flying disc so that the disc is prevented from passing through the disc bay even if the disc is orientated diagonally between opposing vertices (corners) of the disc capture bay.

The vertical distance between bow string and the elongate bar is slightly greater than a thickness of the targeted or standard flying disc, and the vertical distance between the bow string and the elongate bar establishes the vertical dimension of each disc capture bay. The vertical distance and the vertical dimension are slightly greater than the thickness of the targeted or standard flying disc so that the flying disc is allowed to extend into the disc bay from one side. However, the vertical distance and dimension should not be so great that, in combination with the lateral distance and dimension, the resulting diagonal dimension of the disc capture bay would allow the targeted or standard flying disc to pass through the disc bay in a diagonal orientation.

In some embodiments, the targeted or standard flying disc may be a disc golf disc. Disc golf is an activity, game or sport in which players throw a disc at a target using rules similar to golf. The dimensions of a standard disc golf disc may be established by rules of the Professional Disc Golf Association (PDGA). The rules may limit the diameter of a disc golf disc to 30 centimeters, but most discs have a diameter between 21 and 24 centimeters and a thickness between 1.6 and 2.0 centimeters. Various shapes of disc golf discs may be described as putters, mid-range discs, fairway drivers, and distance drivers, but each of these shapes includes a rim camber that rises no more than about half of the thickness of the disc. This means that the rim camber may often have a height of between 0.8 and 1.0 centimeters. Furthermore, if the disc has settled into dirt, mud, or sand, only a portion of the rim camber may be accessible above the surface supporting the disc.

In some embodiments, the lateral distances or dimensions between adjacent pairs of posts and/or struts may be between 20 and 20.9 centimeters and the vertical distance or dimension may be between 1.3 and 3.5 centimeters. Optionally, the vertical distance or dimension may be between 2 and 3 centimeters. Such lateral and vertical distances and/or dimensions may be suitable to capture a range of standard sized disc golf discs. However, lateral and vertical distances and/or dimensions may be further modified to capture a disc having a particular diameter and/or thickness or discs having a range of diameters and/or thicknesses.

In some embodiments, the one or more posts may be a single post dividing an opening bounded by the elongate bar, bow string and the first and second struts into two side-by-side disc capture bays. In an alternative embodiment, the one or more posts may include two posts dividing the opening bounded by the elongate bar, bow string and the first and second struts into three side-by-side disc capture bays. Other embodiments may have further numbers (n) of posts that divide the opening into a greater number (n+1) of disc capture bays. However, for each additional disc capture bay that may be included side-by-side in the bow, the total lateral dimension of the bow must increase by the lateral distance or dimension of the additional disc capture bay. For example, if each disc capture bay had a lateral dimension of about 20 centimeters, then a bow including one post forming 2 bays would need to have a total lateral dimension of about 40 centimeters and a bow including two posts forming 3 bays would need to have a total lateral dimension of about 60 centimeters. Similarly, a bow including some number “n” posts forming “n+1” bays would need to have a total lateral dimension of about (n+1)×20 centimeters. While a flying disc retrieval tool having a larger total lateral dimension may be marginally heavier or difficult to handle, the larger total lateral dimension increases the area that can be covered by a single pass of the bow over the surface supporting the disc. This increased area of coverage may be particularly beneficial where the disc is known to be located in a general area but can't be seen by the person using the tool. For example, if the disc accidentally lands in a body of water that is cloudy or dirty, it may not be possible for a person to see the disc to precisely position a disc retrieval tool having only a single disc capture frame. Furthermore, the person may be the same person that threw the errant disc, such that the person was a considerable distance from where the disc landed. From such a considerable distance, the person may be left to make a rough guess as to whether the disc is located. A bow having a greater or wider total lateral dimension with multiple bays will reduce the amount of time necessary to search a broad area for the disc.

In some embodiments, the bow may form multiple disc capture bays (alternatively referred to as disc snares), wherein each disc capture bay is bounded on a top side by a portion of the elongate rigid bar, bounding on the bottom side by a portion of the bow string, bounded on a right side by one of the first end, the second end or a post, and bounded on a left side by one of the first end, the second end or a post. A first distance between the top side and the bottom side of each disc capture bay may be greater than a thickness of the flying disc and the shoulder or stop element on the one or more posts preferable keeps the first distance at least as great as the thickness of the flying disc. A second distance between the right side and the left side of each disc capture bay may be between 75% and 99% of a diameter of the targeted or standard disc. While the first and/or second distances should not allow the disc to pass through the disc capture bay, the size of the disc capture bay may affect how well or stable the disc is captured within the bay. Specifically, a narrow bay having a small second distance from right to left side will only allow a small portion of the disc to enter into the bay, such that the disc may be knocked loose from the bay prior to being retrieved. A wider bay having a second distance (width) between 75% and 99% of the diameter of the targeted or standard disc will allow a larger portion of the disc to enter into the bay and reduce the likelihood of the disc becoming dislodged from the bay.

In some embodiments, the one or more posts may each include a lateral hole extending therethrough, and the bow string may extend through the lateral hole in each of the one or more posts. Preferably, the bow string is slidably received through the lateral hole, rather than being permanently attached. The lateral hole through each of the one or more posts is preferably located near a distal end of the post. Similarly, the central portion of the bow string preferably extends from a distal edge of the first strut to a distal edge of the second strut. Accordingly, the bow string is preferably positioned and supported near the very lowest or most distal position of the bow, such that the bow string has an optimal position for either directly passing under an edge of the disc or initially engaging the rim camber of the disc before sliding under the disc. Furthermore, the bow string is very thin to further increase the likelihood of the bow string engaging the rim camber of the disc or passing under the disc.

In some embodiments, the distal edge of the first strut may include a first notch through which the bow string passes to prevent the bow string from sliding along, or slipping off, the distal edge of the first strut. Similarly, the distal edge of the second strut may include a second notch through which the bow string passes to prevent the bow string from sliding along, or slipping off, the distal edge of the second strut.

In some embodiments, the bow string may pass through the first notch, pass through first and second holes in the first strut, and may be prevented from pulling through the second hole in the first strut by a first stop sleeve that is crimped to the first end of the bow string. Similarly, the bow string may pass through the second notch, pass through first and second holes in the second strut, and may be prevented from pulling through the second hole in the second strut by a second stop sleeve that is crimped to the second end of the bow string. Other fasteners or means may be used to secure the first and second ends of the bow strings to the first and second struts, respectively.

In some embodiments, the distal edge of the first strut, the distal edge of the second strut and the lateral hole through each of the one or more posts are alignable so that the bow string is able to extend in a straight line between the first and second struts. In one option, the first and second ends of the bow string are secured to the first and second struts so that the central portion of the bow string is under tension. Still, the first and second struts and/or the elongate bar may each flex slightly allowing for some displacement of the bow string away from the straight line. For example, if the bow is drawn over an area of the surface that is slightly convex, one or more post may be pushed upward (proximally) a distance through a post hole in the elongate bar and the bow string may bend to follow the convex curvature of the surface. The ability of the flexible bow string to bend or are over a convex surface increases the likelihood of capturing the disc. By contrast, a solid frame or rod will ride on top of convex ridges and/or pass over concave depressions on/in the surface supporting the disc such that the disc may not be captured. Without limitation, the elongate bar and struts may be made from aluminum 6061 or 5052, although other non-corrosive materials such as plastics or fiberglass could be used. Specifically, the elongate bar and struts may have a width of about 0.75 (¾) inch, a thickness of about 0.125 (⅛^{th}) inch, a lateral dimension of about 24 inches, and struts that extend about 1 inch in a vertical dimension (perhaps with a ⅜ inch bend radius between the elongate bar and each strut. Preferably, the entire bow structure will be made with lightweight (i.e., not a heavy weight) so as not to cause failure or undue stress on the extendable handle (telescopic pole) at full extension.

In some embodiments, the elongate bar may include a post hole for receiving each post (i.e., one post hole per post). Each post may include a shank extending through a respective post hole and a head disposed above the elongate bar that will not pull through the post hole. Optionally, the shank of each post may further include a shoulder or stop element disposed below the elongate bar that will not pull through the post hole, wherein the head and the shoulder are spaced apart on the shank to allow a portion of the shank between the head and the shoulder to move axially (i.e., up and down) through the post hole. Due to the enabled axial movement, each post may be alternatively referred to as a floating post. These floating posts enable the bow string to adapt to surface irregularities or undulations on the surface supporting the disc, such as the bottom of a pond or creek. Furthermore, if the surface is a soft material, such as mud or sand, the post may be extend into the soft material so that the bow string moves underneath the disc even if the disc is partially buried in the soft material. The combination of the floating posts and the bow string allow each disc capture bay to closely follow the surface and increase the likelihood of capturing the disc.

The shoulder or stop element may take many forms to set a limit to how much of the post may slide upward through the post hole in the elongate bar. As the post slides upward, the bow string gets closer to the elongate bar and the effective vertical dimension of the disc capture bay is decreased. The shoulder or stop element is preferably positioned on the post so that the vertical dimension of the disc capture bay is never less that the average thickness of a targeted or standard disc and/or the bow string cannot raise so high that the bow string might pass over the top of a disc. Without limitation, the shoulder or stop element may be a stop collar, pin extending through a hole through the post, or a threaded nut received on a threaded shaft. In one option, the post may be formed with a 2-hole clevis pin, where a first upper hole through the clevis pin receives another pin, such as a slotted roll pin, to form the shoulder or stop element and where the bow string extends through a second lower hole through the clevis pin. Once the post has slid upward through the post hole to the point that the shoulder or stop element engages the lower surface of the elongate bar, the post resists further upward movement and may be pushed into a surface of soft material.

In some embodiments, the extendable handle may be a telescoping pole. Optionally, the telescoping pole may have a fully extended length (reach) of approximately 19 feet yet may telescopically compress (retract) to a fully retracted length of about 17 inches. A telescoping pole may include a plurality of hollow tubular sections which are slideably received within each other. In one option, the telescoping pole may be formed with a corrosion resistant material, such as stainless steel, aluminum or a polymeric material. In another option, a gripping material applied to the outermost tubular section of the telescoping pole to make the pole easier for a person to grip even when the pole is wet. In a further option, one or more holes may be formed in one or more of the hollow tubular sections to enable water drainage after the pole has been submersed. In yet another option, the extendable handle may secure a pair of straps with fasteners, such as book and loop fasteners, which may be used to secure the bow and the handle together in a parallel configuration for storage. For example, the elongate bar may be disconnectable from the extendable handle, such that the bow and the handle may be laid side-by-side and strapped together using the straps with fasteners. Optionally, the straps or other fasteners may be secured to the extendable handle, perhaps with an adhesive or screw.

In some embodiments, the flying disc retrieval tool may further comprise a bracket (stop plate) connected to the extendable handle and including a rigid arm extending laterally from the extendable handle, wherein the extendable handle is pivotally connected to the elongate bar, the rigid arm includes a first alignment hole, and the elongate bar includes a second alignment hole. The tool may further comprise an alignment pin that is secured through the first and second alignment holes to securely position the extendable handle perpendicular to the elongate bar. The alignment pin may be removable to allow the extendable handle to pivot so that the extendable handle is parallel to the elongate bar without disconnecting the handle from the elongate bar. The alignment pin may take many forms, such as a bolt/nut, a spring plunger (spring lock and release mechanism) or a quick release pin (also known as a ball lock pin). In one option, the alignment pin may be removable from the second alignment hole in the elongate bar but retained in the first alignment hole in the rigid arm of the bracket.

In some embodiments, the bow string may be a corrosion resistant string or wire, such as a stainless steel wire. Preferably, the bow string is able to flex or bend. The bow string should be as thin as practical to pass under the edge of the disc but needs to have enough tensile strength to not stretch or break when the disc is captured in the disc capture bay or when the bow string engages and rakes over a rock. Still further, the bow string is preferably able to hold the slight, constant tension that is loaded onto it during its stringing. One suitable option is a stainless-steel wire, rope or cable, optionally with braided or wound strands, having a diameter between 1/16^{th} inch and ⅛^{th} inch diameter.

In some embodiments, the components of the flying disc retrieval tool may be made from lightweight and/or corrosion resistant materials. Non-limiting examples of suitable materials include polymers, polymer composite materials, and various metal alloys, such as aluminum alloys, titanium alloys or stainless steel. Furthermore, the material selected for each component may be independently selected, such that the flying disc retrieval tool may include components of various different materials. For example, the extendable handle and bow could be made from an aluminum alloy, the posts and any bracket may be made from a polymer or polymer composite, and the bow string may be a stainless steel wire.

Some embodiments provide a method of using the flying disc retrieval tool to retrieve a flying disc. The method comprises extending the extendable handle, resting the bow on a surface that is supporting the disc in a position beyond the disc, pulling the handle to draw the bow along the surface until the disc is captured in one of the plurality of side-by-side disc capture bays, and retrieving the disc from the bow. The method may use any embodiment of the flying disc retrieval tool described herein.

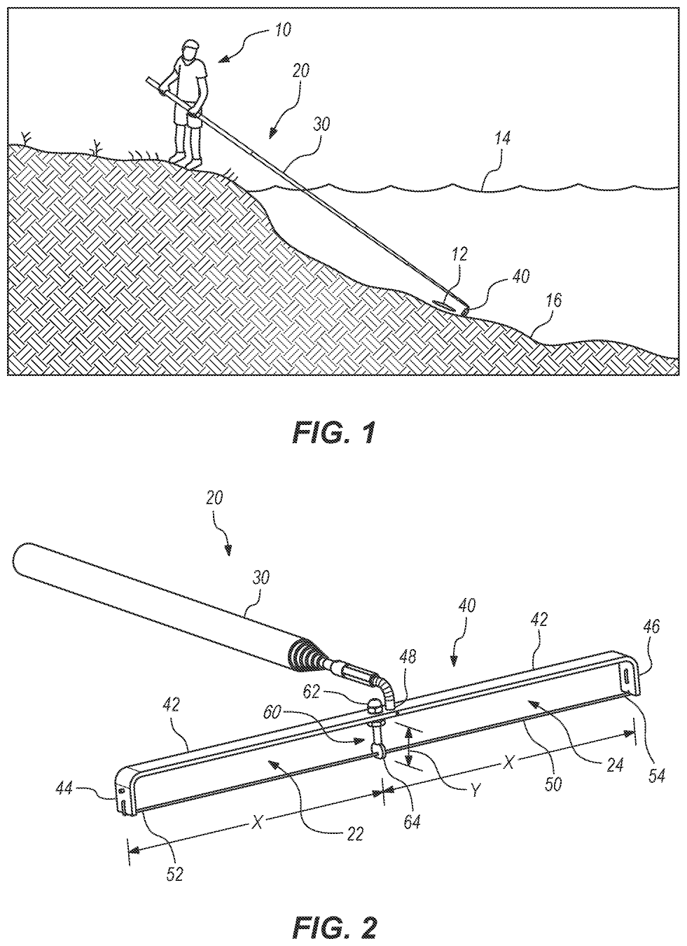

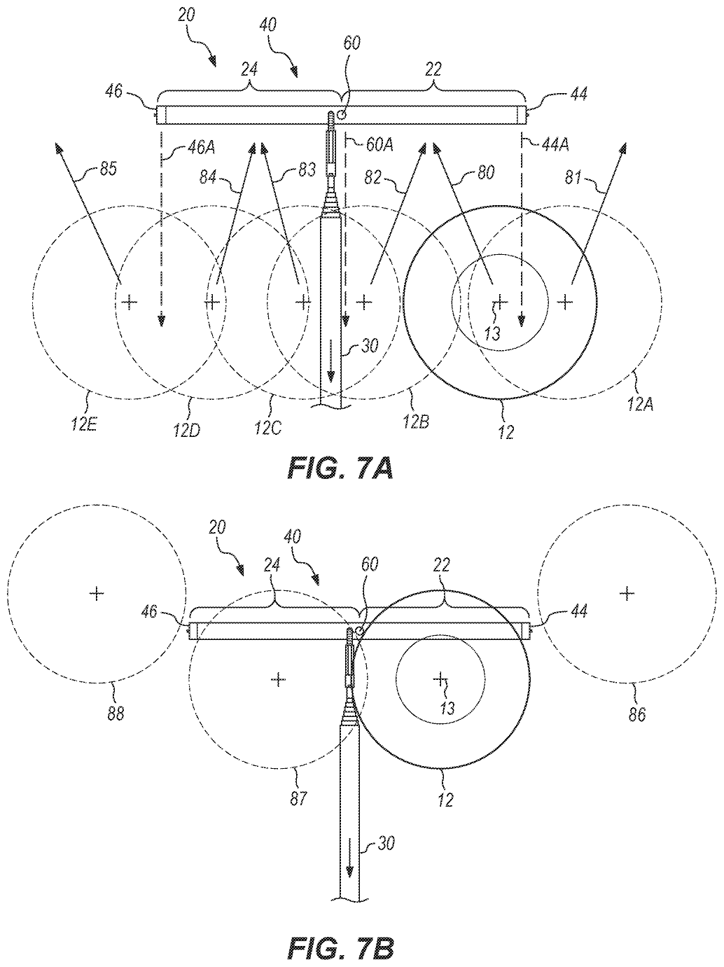

FIG. 1 is an illustration of a person 10 using a flying disc retrieval tool 20 to retrieve a flying disc 12 from a pond 14. The disc 12 is supported by a surface 16 at the bottom of the pond 14. The tool 20 includes a telescoping handle 30 and a bow 40 connected to the handle 30. The person 10 has extended the telescoping handle 30 and rested the bow 40 on the surface 16 that is supporting the disc 12 in a position beyond the disc 12 relative to the person 10. In the position shown, the person 10 may then pull the handle 30 to draw the bow 40 along the surface 16 until the disc 12 is captured in one of a plurality of side-by-side disc capture bays (now shown; see FIG. 2). With the disc 12 captured in a disc capture bay (not shown; see FIGS. 7A, 7B, 8A, 8B and 9), the person may continue to pull the flying disc retrieval tool 20 toward them and out of the pond 14 to retrieve the disc 12 from the bow 40.

FIG. 2 is a perspective view of the flying disc retrieval tool 20 according to one embodiment. The flying disc retrieval tool 20 includes the extendable handle 30 and the bow 40 including an elongate bar 42 connected to the extendable handle. The connection between the handle 30 and the bow 40 may form any angle, may have an adjustable angle, or may have a fixed angle. In many of the Figures herein, the extendable handle 30 is a telescopically extendable handle shown in a collapsed or retracted condition for convenience of illustration. However, it should be recognized that the extendable handle 30 will typically be in the extended condition during use as shown in FIG. 1.

A first strut 44 is downwardly extending from a first (left) end of the elongate bar 42 and a second strut 46 downwardly extending from a second (right) end of the elongate bar 42. The tool 20 further includes a bow string 50 having a first end 52 secured to the first strut 44, a second end 54 secured to the second strut 46. A central portion of the bow string 50 extends from the first strut 44 to the second strut 46, wherein the first and second struts 44, 46 position the bow string 50 a vertical distance (Y) from the elongate bar 42. Still further, the tool 20 includes a post 60 having a first (upper) end 62 coupled to the elongate bar 42 and a second (lower) end 64 coupled to the bow string 50. The post 60 is coupled to the elongate bar 42 at a position providing substantially uniform lateral distances (X) between the first strut 44 and the post 60 and between the second strut 46 and the post 60. In this example, the post 60 is substantially centered between the first and second struts 44, 46 to form first and second side-by-side disc capture bays 22, 24. To avoid interference with the post 60, the handle is connected to the elongate bar 42 at a point 48 immediately adjacent to the post 60, which is slightly off-center of the elongate bar 42. Optionally, the struts 44, 46 could be separate components secured to the elongate bar 42 but, as shown here, the struts 44, 46 are preferably formed a single component with the elongate bar 42. The single components may be a metal bar that is bent on the ends to create the struts or may be formed with a polymeric material.

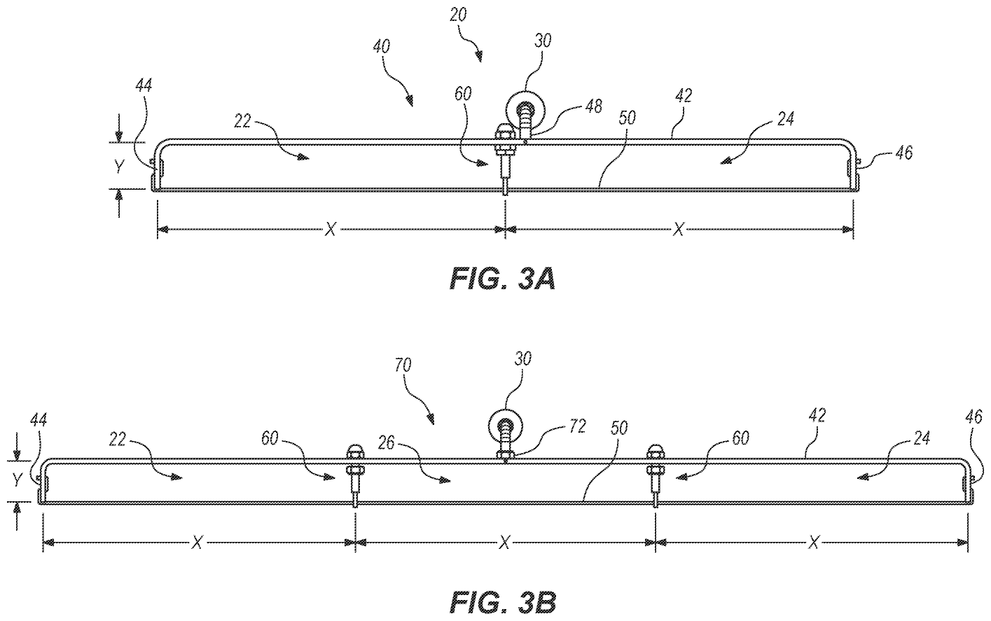

FIGS. 3A-B are end views showing two embodiments of the flying disc retrieval tool having a first bow 40 forming two disc capture bays 22, 24 and a second bow 70 forming three disc capture bays 22, 24, 26, respectively. In FIG. 3A, the bow 40 has a single post 60 forming two disc capture bays 22, 24 consistent with the embodiments shown in FIG. 2. However, in the end view of the flying disc retrieval tool 20 in FIG. 3A, it is easier to see the identical size of the two disc capture bays 22, 24 and the generally rectangular shape of the two disc capture bays 22, 24. Specifically, each bay 22, 24 has a height or vertical dimension “Y” and a width or lateral dimension “X”. The identical or nearly identical size of the disc capture bays is important to provide identical or nearly identical disc capture ability and stability. A disc capture bay that is too large relative to the size of a targeted or standard disc may allow the disc to pass through the opening formed by the bay, whereas a disc capture bay that is too small relative to the size of a targeted or standard disc may be at risk of the disc becoming dislodged from the bay prior to being fully retrieved.

In FIG. 3B, the second bow 70 is similar to the first bow 40 except that it has a greater total lateral dimension and has two posts 60 forming three disc capture bays 22, 24, 26. Each of the three disc capture bays 22, 24, 26 has a height or vertical dimension “Y” and a width or lateral dimension “X” the same as the bays of the first bow 40. The middle bay 26 is bounded on both the left and the right by one of the posts 60, but the middle bay 26 two posts 60 may capture a disc therebetween in the same manner as the other bays 22, 24. However, the total lateral dimension of the bow 70 is roughly 3× whereas the total lateral dimension of the bow 40 is roughly 2×. Because the two posts 60 are evenly spaced along the elongate bar 42, there is no post 60 at the exact center of the elongate bar 42. Accordingly, the handle 30 may be connected to the elongate bar 42 of the bow 70 at the point 72 which is the exact lateral center point of the elongate bar 42.

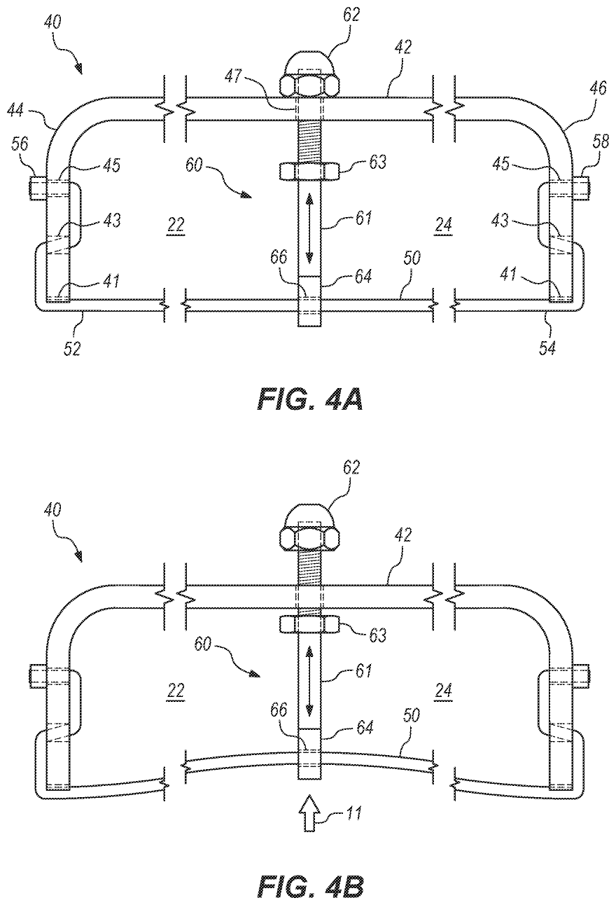

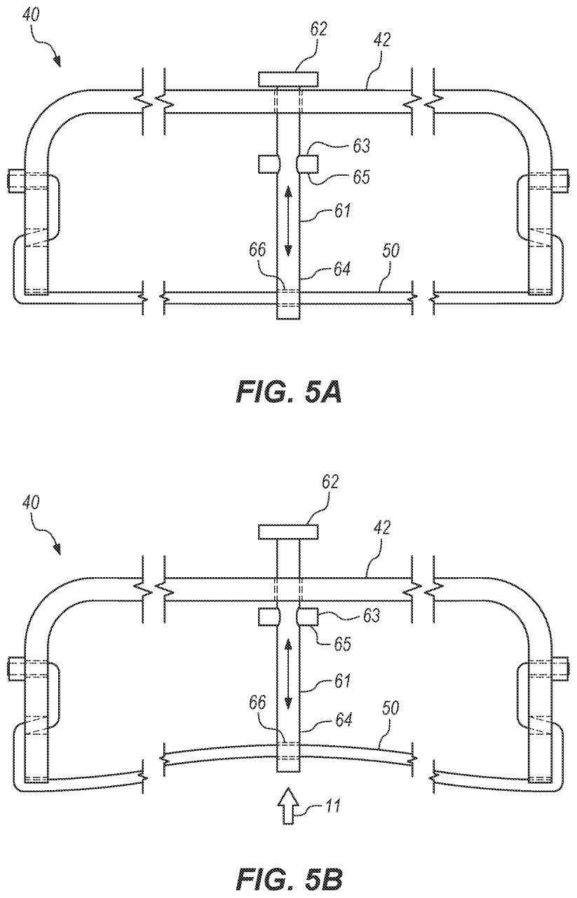

FIGS. 4A-B are partial end views of the bow 40 having first and second struts 44, 46 securing the ends of the bow string 50 and a first embodiment of a post 60 that is connected to both the elongate bar 42 and the bow string 50. First, the flexible bow string 50 has a first end 52 secured to the first strut 44 and a second end 54 secured to the second strut. Both struts 44, 46 include a notch 41 in the distal end of the strut, a first hole 43 through the strut just above the notch 41, and a second hole 45 just above the first hole 43. The first end 52 of the flexible bow string 50 extends under the distal end of the first strut 44 within the notch 41, around an outer face of the first strut 44, inward through the first hole 43, around an inner face of the first strut 44, and then outward through the second hole 45. The terminal end of the first end 52 may then be secured with a first stop sleeve 56 that is crimped around the bowstring 50. Similarly, the second end 54 of the flexible bow string 50 extends under the distal end of the second strut 46 within the notch 41, around an outer face of the second strut 46, inward through the first hole 43, around an inner face of the second strut 46, and then outward through the second hole 45. The terminal end of the second end 54 may then be secured with a second stop sleeve 58 that is crimped around the bowstring 50. The stop elements 56, 58 have a size that won't pull back through the second holes 45.

The post 60 includes a shaft 61 has a first (upper) end that secures a head 62 and a shoulder 63 to couple the post 60 to the elongate bar 42. The shaft 61 also has a second (lower) end 64 having a hole 66 therethrough which receives the bow string 50. The bow string 50 is coupled to the distal second end 64 of the shaft 61 since the bow string 50 will not separate from the shaft 61 unless the bow string is cut or one of the stop sleeves 56,58 is removed.

FIG. 4B illustrates that the post 60 is a “floating” post since there is sufficient distance between the head 62 and the shoulder 63 to allow the post to slide op and down (axially) through the post hole 47 in the elongate bar 42. Both the head 62 and the shoulder 63 have sufficient size to avoid pulling through the post hole 47, but the portion of the shaft 61 between the head 62 and the shoulder 63 may slide through the post bole 47 when pushed up or down. As shown, a force 11 (illustrated by the bold arrow) has pushed the post 60 upward until the shoulder 63 engages the bottom surface of the elongate bar 42. The force 11 may be the result of the bow 40 being pulled across a rock or a convex portion of the surface 16 (see FIG. 1). Note also that the bow string 50 moves upward and downward along with the distal end 64 of the shaft 61 and may slide through the hole 66 in the shaft 61. The ability of the post 60 to float up and down over a limited range and the ability of the bow string 50 to flex and follow the movement of the post 60 allows the bow string 50 (which forms the lower boundary of each disc capture bay 22, 24) to deflect and change its contour to match the contour of the surface upon which the disc is supported.

FIGS. SA-B are partial end views of the bow 40 having first and second struts 44, 46 securing first and second ends of the bow string 50 and a second embodiment of a post 60 that is connected to both the elongate bar 42 and the bow string 50. The post 60 in FIGS. SA-B is functionally the same as that shown in FIGS. 4A-B but does not involve a threaded bolt with threaded nut forming the shoulder or threaded cap nut forming the head (as illustrated in FIGS. SA-B). Rather, the post 60 may be formed as a clevis pin with a head 62, a first hole receiving and securing the bow string 50 and a second hole securing a lateral pin 65 that forms the shoulder 63.

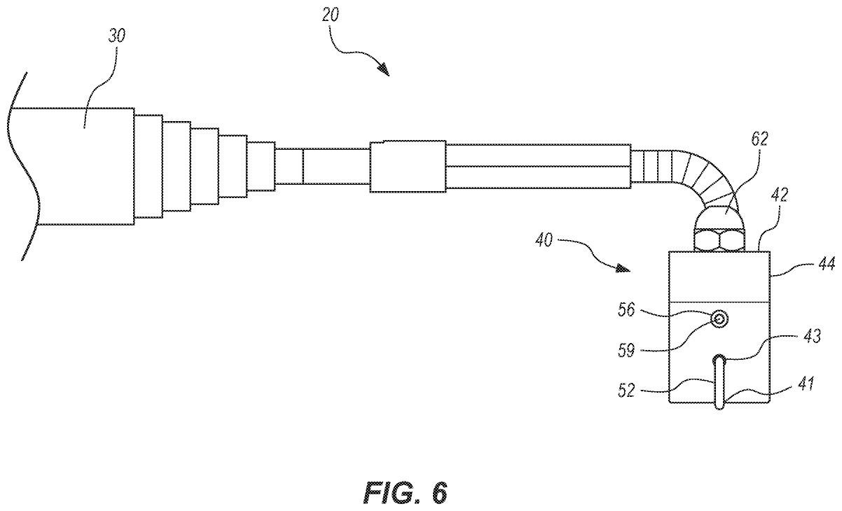

FIG. 6 is a partial side view of the flying disc retrieval tool 20 showing the first end 52 of the bow string secured to the first strut 44 of the bow 40. The first end 52 of the bow string extends under the distal end of the first strut 44 and passes within the notch 41, around an outer face of the first strut 44, inward through the first hole 43, around an inner face of the first strut 44, and then outward through the second hole 45 (not shown; see FIG. 4A). The terminal end 59 of the first end 52 is secured with the first stop sleeve 56 that is crimped around the bowstring 50.

FIGS. 7A-B are schematic top views of the flying disc retrieval tool 20 illustrating how a disc 12 is drawn or directed into one of the bays 22, 24. A targeted disc 12 is shown in solid lines, but alternative placements of the targeted disc are shown in dashed lines. It should be appreciated that, when attempting to capture the disc 12, the bow 40 may engage the disc 12 at various points across the width of the bow 40. This is especially true when the person using the tool 20 is unable to see the disc 12, such as when the disc 12 is submersed in a pond, such that it is not possible to precisely align a disc capture bay 22, 24 with the disc 12.

With the disc 12 supported on a surface, a person extends the handle 30 so that the bow 40 may be positioned beyond the area where the disc 12 may be located. The person then pulls the handle 30 toward themselves (see the arrow superimposed on the handle 30). If the disc is in the path of the bow 40, then the disc will initially contact either the first strut 44, the second strut 46, or the post 60. A path of the first strut 44 is illustrated by a dashed arrow 44A, a path of the second strut 46 is illustrated by a dashed arrow 46A, a path of the post 60 is illustrated by a dashed arrow 60A.

If the disc 12 (shown in solid lines) is in the path of the first strut 44 (see the path 44A) to the right hand side of a center point 13, then the disc 12 will be deflected to the left generally along the path 80 until the disc 12 is captured in the first disc capture bay 22 (as shown in FIG. 7B). When fully captured, the disc 12 will engage both the first strut 44 and the post 60 that define the lateral boundaries of the first disc capture bay 22.

If the disc is in position 12A (shown in dashed lines), then the disc is still in the path of the first strut 44 (see the path 44A) but the path is to the left hand side of the center point 13. Accordingly, the disc will be deflected to the right generally along the path 81 such that the disc 12 is not captured in either disc capture bay. Rather, the disc ends up in the position 86 (as shown in FIG. 7B).

If the disc is in position 12B (shown in dashed lines), then the disc is in the path of the post 60 (see the path 60A) to the left hand side of the center point 13. Accordingly, the disc will be deflected to the right generally along the path 82 until the disc is captured in the first disc capture bay 22 (the same position as disc 12 shown in FIG. 7B). When fully captured, the disc will engage both the first strut 44 and the post 60 that define the lateral boundaries of the first disc capture bay 22.

If the disc is in position 12C (shown in dashed lines), then the disc is again in the path of the post 60 (see the path 60A) but to the right hand side of the center point 13. Accordingly, the disc will be deflected to the left generally along the path 83 until the disc is captured in the second disc capture bay 24. The second disc capture bay 24 is shown in FIG. 7B with a fully captured disc in position 87 (shown in dashed lines). When fully captured, the disc will engage both the second strut 46 and the post 60 that define the lateral boundaries of the second disc capture bay 24.

If the disc is in position 12D (shown in dashed lines), then the disc is in the path of the second strut 46 (see the path 46A) to the left hand side of the center point 13. Accordingly, the disc will be deflected to the right generally along the path 84 until the disc is captured in the second disc capture bay 24. The second disc capture bay 24 is shown in FIG. 7B with a fully captured disc in position 87 (shown in dashed lines). When fully captured, the disc will engage both the second strut 46 and the post 60 that define the lateral boundaries of the second disc capture bay 24.

If the disc is in position 12E (shown in dashed lines), then the disc is again in the path of the second strut 46 (see the path 46A) but the path is to the right hand side of the center point 13. Accordingly, the disc will be deflected to the left generally along the path 85 such that the disc is not captured in either disc capture bay. Rather, the disc ends up in the position 88 (as shown in FIG. 7B).

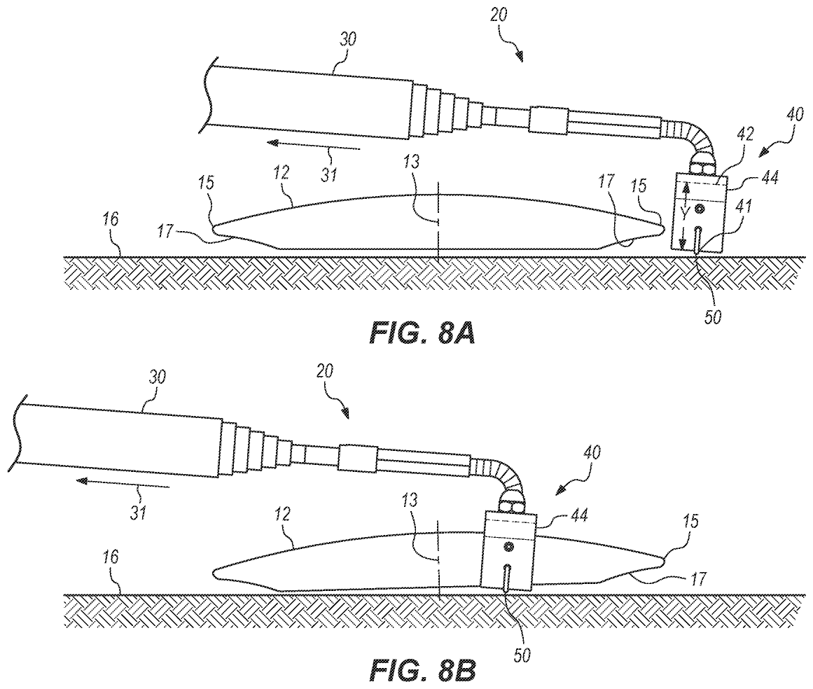

Notice that the bow 40 will capture any disc that has its center point between the path of the first strut 44 and the path of the second strut 46. Having the side-by-side disc capture bays 22, 24 means that the bow 40 provides a wide disc capture zone and the person attempting to retrieve a disc does not need to be so precise or lucky in order to capture the disc. Additional benefits of the flying disc retrieval tool 20 are described below in reference to FIGS. 8A-B.

FIGS. 8A-B are schematic side views of the flying disc retrieval tool 20 illustrating how a disc 12 is captured in one of the disc capture bays of the bow 40. In FIG. 8A, the disc 12 is being supported on the surface 16 and the bow 40 has been positioned onto the same surface 16 beyond the disc 12 (to the right in FIG. 8A where the handle 30 extends to the left to be pulled in the direction of the arrow 31. The bow 40 forms the disc capture bays (not shown) that have a height Y between the elongate bar 42 and the bow string 50, where the bow string 50 extends laterally between the distal ends of the first and second struts 44, 46 of the bow 40. In the embodiment shown, the bow string 50 is received in the notch 41 along the distal end of the strut 44.

The disc 12 may be, for example, a standard disc for playing disc golf. A disc golf disc, as with other flying discs, is axially symmetric about the center axis 13 such that the disc has the same profile regardless of its rotational orientation. Therefore, regardless of the angle at which the bow 40 approaches the disc 12, the disc 12 presents a rim 15 having a rim camber 17. The rim camber 17 is the lower side of the leading (outer) edge or rim 15 of the disc 12. The shape and width of the rim camber 17 may vary between various types of discs, such as putters, mid-range discs, fairway drivers and distance drivers, in order to change the aerodynamics and performance of the disc. However, for the purpose of capturing the errant disc 12, the height of the rim camber 17 roughly half of the thickness of the relatively thin disc 12. Accordingly, the flying disc retrieval tool 20 provides a thin and flexible bow string 50 at the distal (lower) end of the struts 44, 46 in order to have a high probability of bow string 50 aligning with the rim camber 17 of the disc 12. In other words, the bow string 50 must be lower than the lead edge or rim 15 in order to slide under the disc 12 and have any chance of capturing the disc 12. Having a thin bow string 50, such as a flexible stainless steel wire, at the lowest point of the bow 40 improves the probability of a successful disc capture.

In FIG. 8B, the flying disc retrieval tool 20 has been pulled in the direction of the arrow 31 relative to the position of the tool in FIG. 8A. Accordingly, the bow string 50 engaged the rim camber 17 and slid under the disc 12, perhaps slightly lifting the right side of the disc 12. The bow string 50 may continue sliding under the disc 12 until the rim of the disc 12 engages the lateral edges of a disc capture bay, such as the post 60 and the first strut 44 of the first disc capture bay 22 (see FIG. 7B).

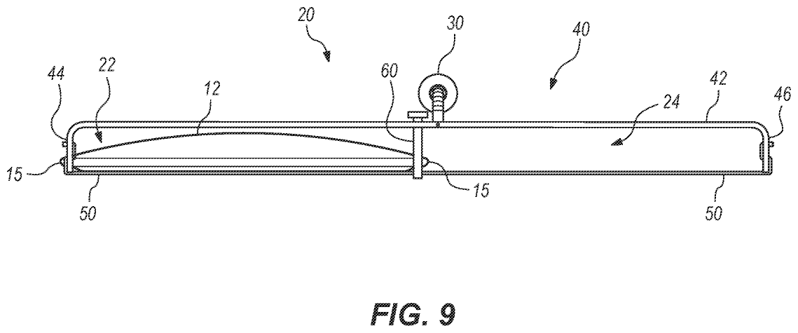

FIG. 9 is an end view of the flying disc retrieval tool 20 that has captured a disc 12 the first disc capture bay 22. As also shown in FIGS. 7B and 8B in top and side views, the end view of FIG. 9 shows a portion of the disc 12 received between the elongate bar 42, the first strut 44, the bow string 50 and the post 60. However, because the lateral dimension of the disc capture bay 22 is slightly less than the diameter of the disc 12, the rim 15 of the disc 12 can be seen extending laterally left of the first strut 44 and laterally right of the post 60 on the same side of the bow 40 as the handle 30.

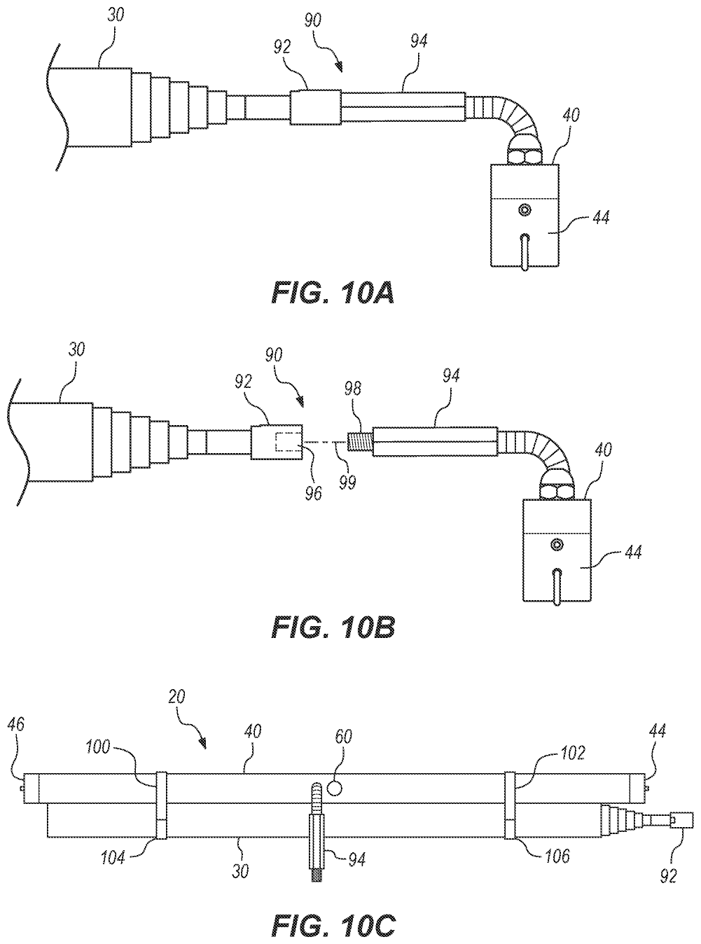

FIGS. 10A-B are partial side views of the flying disc retrieval tool 20 illustrating a connection 90 between the handle 30 and the bow 40. While the connection may be permanent, the connection 90 is manually disconnectable. For example, a person may grasp a first connection element 92 in one hand and grasp a second connection element 94 in another hand to disconnect or connect the elements 92, 94. As shown best in FIG. 10B, the connections elements 92, 94 may include external screw threads 98 and mating internal screw threads 96. Accordingly, the person may turn the first and second connection elements 92, 94 in opposite directions about their axis 99 to connect and/or disconnect the handle 30 to/from the bow 40.

FIG. 10C is a top view of the bow 40 and the disconnected handle 30 positioned side-by-side and strapped together for storage. The straps 100, 102 may be, for example, straps with overlapping hook and loop fastener elements from rapidly securing and releasing the ends of each strap so that the handle and bow may be easily held together or separated for assembly and use of the flying disc retrieval tool 20.

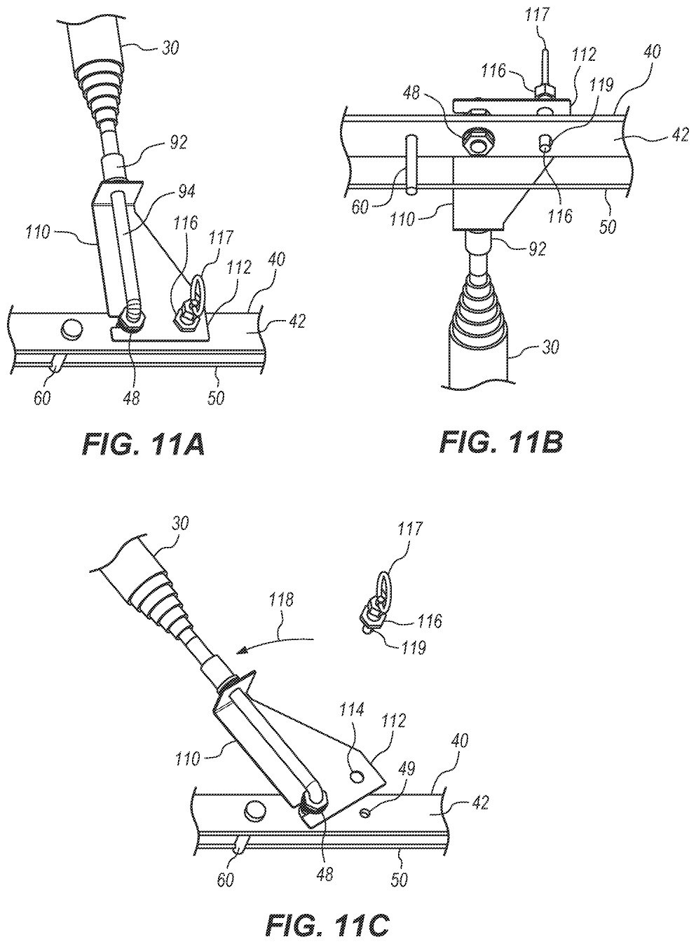

FIGS. 11A-B are top and bottom perspective views of a handle bracket 110 (stop plate) that supports the handle 30 at a fixed angle to the bow 40. The handle bracket 110 is removably or permanently connected to the extendable handle 30 and includes a rigid arm 112 extending laterally from the extendable handle 30. The extendable handle 30 is pivotally connected to the elongate bar 42 at point 48, the rigid arm 112 includes a first alignment hole 114, and the elongate bar 42 includes a second alignment hole 49. The tool may further comprise an alignment pin 116 that is secured through the first and second alignment holes 114, 49 (see also FIG. 11C) to securely position the extendable handle 30 perpendicular to the elongate bar 42 as shown in FIG. 11A. The alignment pin 116 may take many forms, such as a bolt/nut, a spring plunger (spring lock and release mechanism) or a quick release pin (also known as a ball lock pin). The alignment pin 116 includes a knurled finger pull 117 and a spring-loaded ball 119 that may prevent the alignment pin from accidentally pulling out the alignment holes.

FIG. 11C is a top perspective view of the handle bracket 110 in a released condition allowing the handle 30 to pivot relative to the bow 40. The alignment pin 116 has been removed from the first and second alignment holes 114, 49 to allow the extendable handle 30 to pivot (see arrow 118). Optionally, the extendable handle 30 may be pivotable into a position that is parallel to the elongate bar 42 without disconnecting the handle from the elongate bar. In one option, the alignment pin 116 may be removable from the second alignment hole 49 in the elongate bar 42 but retained in the first alignment hole 114 in the rigid arm 112 of the bracket 110 so that the alignment pin 116 won't get misplaced.

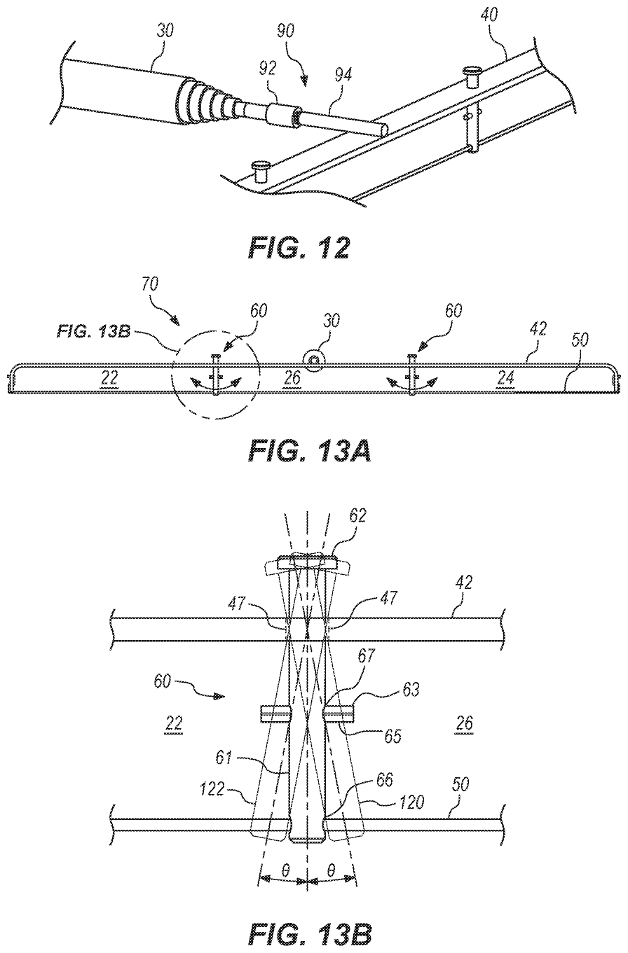

FIG. 12 is a perspective view of the handle 30 connected to the bow 40 according to an alternative embodiment. The connection 90 between a first connection element 92 and a second connection element 94 may be a threaded connection as was shown in FIGS. 10A-B, how the second connection element 94 is connected flush with the top surface of the bow 40 rather than forming a 90-degree bend as in FIGS. 10A-B. For example, the second connection element 94 may include a straight metal rod that is welded to the bow 40 along both sides of the rod.

FIGS. 13A-B are end views of the bow 70 illustrating potential lateral deflection of a post 60. The post 60 is formed as a clevis pin with a head 62, a first hole 66 receiving and securing the bow string 50 and a second hole 67 securing a lateral pin 65 that forms the shoulder 63. The shaft 61 of the post 60 may move up and down through the post hole 47 in the elongate bar 42, FIGS. 13A-B illustrate the side-to-side deflection of the post 60 that is possible. To facilitate the up and down sliding through the post hole 47, a diameter of the shaft 61 must be less than the diameter of the post hole 47. However, the difference in the diameters of the post hole 47 and the shaft 61 leaves a gap therebetween. As a result of the gap, the shaft 61 of the post 60 may deflect in a lateral direction (left and right in FIGS. 13A-B) to an angle that is limited by the post hole 47. The extent of the lateral deflection can be controlled by modifying the diameter of the shaft 61 and/or the diameter of the post hole 47. However, the maximum amount of deflection for the post 60 may be taken into account as affecting the width of a disc capture bay of either side of the post 60. For example, if a disc 12 is captured in the disc capture bay 22 (see also FIG. 9), the disc 12 may push the post 60 to the right (see position 120) to the full extent of the post deflection. Accordingly, if the width of the disc capture bay 22 is intended to be no more than X, then the centerline of the post hole 47 may need to be adjusted so that the width of the bay 22 is no more than X with the post 60 fully deflected to the right. Furthermore, if the disc 12 is captured in the middle disc capture bay 26 (see also FIG. 13A showing bay 26 as the middle bay of a bow having three bays), the disc 12 may push the post 60 to the left (see position 122) to the full extent of the post deflection. Since the middle bay 26 has a post on the left (as shown) and on the right (not shown in FIG. 13B, but see FIG. 13A), the left post may deflect to the left (see position 122) while the right post may deflect to the right (to a position similar to position 120). Essentially, the disc will tend to move into the bay 26 and push the left and right posts apart. Accordingly, if the width of the disc capture bay 26 is intended to be no more than X, then the centerline of the post hole 47 for both posts may need to be adjusted so that the width of the bay 26 is no more than X with the two posts 60 fully deflected apart (away from each other).

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A flying disc retrieval tool, comprising:
an extendable handle;
a bow including an elongate bar connected to the extendable handle, a first strut downwardly extending from a first end of the elongate bar and a second strut downwardly extending from a second end of the elongate bar;
a bow string having a first end secured to the first strut, a second end secured to the second strut, and a central portion that extends from the first strut to the second strut, wherein the first and second struts position the bow string a vertical distance from the elongate bar; and
one or more posts, each post having a first end coupled to the elongate bar and a second end coupled to the bow string, wherein the one or more posts are coupled to the elongate bar at positions providing substantially uniform lateral distances between the first strut and one of the posts closest to the first strut, between the second strut and one of the posts closest to the second strut, and between any adjacent pair of the posts to form a plurality of side-by-side disc capture bays.

2. The flying disc retrieval tool of claim 1, wherein the lateral distances are slightly less than a diameter of a targeted flying disc and the vertical distance is slightly greater than a thickness of the targeted flying disc.

3. The flying disc retrieval tool of claim 2, wherein the flying disc is a disc golf disc.

4. The flying disc retrieval tool of claim 3, wherein the lateral distances are between 20 and 20.9 centimeters and the vertical distance is between 1.3 and 3.5 centimeters.

5. The flying disc retrieval tool of claim 1, wherein the one or more posts is a single post dividing an opening bounded by the elongate bar, bow string and the first and second struts into two side-by-side disc capture bays.

6. The flying disc retrieval tool of claim 1, wherein the one or more posts includes two posts dividing an opening bounded by the elongate bar, bow string and the first and second struts into three side-by-side disc capture bays.

7. The flying disc retrieval tool of claim 1, wherein the one or more posts each include a lateral hole extending therethrough, and wherein the bow string extends through the lateral hole in each of the one or more posts.

8. The flying disc retrieval tool of claim 7, wherein, for each of the one or more posts, the lateral hole is located near a distal end of the post.

9. The flying disc retrieval tool of claim 8, wherein the central portion of the bow string extends from a distal edge of the first strut to a distal edge of the second strut.

10. The flying disc retrieval tool of claim 9, wherein the distal edge of the first strut includes a first notch through which the bow string passes to prevent the bow string from sliding along the distal edge of the first strut, and wherein the distal edge of the second strut includes a second notch through which the bow string passes to prevent the bow string from sliding along the distal edge of the second strut.

11. The flying disc retrieval tool of claim 10, wherein the bow string passes through the first notch, passes through first and second holes in the first strut, and is prevented from pulling through the second hole in the first strut by a first stop sleeve that is crimped to the first end of the bow string, and wherein the bow string passes through the second notch, passes through first and second holes in the second strut, and is prevented from pulling through the second hole in the second strut by a second stop sleeve that is crimped to the second end of the bow string.

12. The flying disc retrieval tool of claim 9, wherein the distal edge of the first strut, the distal edge of the second strut and the lateral hole through each of the one or more posts are alignable so that the bow string is able to extend in a straight line between the first and second struts.

13. The flying disc retrieval tool of claim 12, wherein the first and second ends of the bow string are secured to the first and second struts so that the central portion of the bow string is under tension.

14. The flying disc retrieval tool of claim 8, wherein the elongate bar includes a post hole for receiving each post, and wherein each post includes a shank extending through the post hole and a head disposed above the elongate bar that will not pull through the post hole.

15. The flying disc retrieval tool of claim 14, wherein the shank of each post further includes a shoulder disposed below the elongate bar that will not pull through the post hole, and wherein the head and the shoulder are spaced apart on the shank to allow a portion of the shank between the head and the shoulder to move axially through the post hole

16. The flying disc retrieval tool of claim 1, wherein the extendable handle is a telescoping pole.

17. The flying disc retrieval tool of claim 1, wherein the elongate bar is disconnectable from the extendable handle.

18. The flying disc retrieval tool of claim 1, further comprising:
a bracket connected to the extendable handle and including a rigid arm extending laterally from the extendable handle, wherein the extendable handle is pivotally connected to the elongate bar, the rigid arm includes a first alignment hole, and the elongate bar includes a second alignment hole; and
an alignment pin that is secured through the first and second alignment holes to securely position the extendable handle perpendicular to the elongate bar, wherein the alignment pin is removable to allow the extendable handle to pivot so that the extendable handle is parallel to the elongate bar.

19. The flying disc retrieval tool of claim 1, wherein the bow string is a stainless steel wire.

20. A method of using the flying disc retrieval tool of claim 1 to retrieve a flying disc, comprising:
extending the extendable handle;
resting the bow on a surface that is supporting the disc in a position beyond the disc;
pulling the handle to draw the bow along the surface until the disc is captured in one of the plurality of side-by-side disc capture bays; and
retrieving the disc from the bow.
